(19) United States
(12) Patent Application Publication
(10) Pub. No.: US 2006/0103133 A1
(43) Pub. Date: May 18, 2006

(54) Joining element

(76) Inventors: Erminio Moretti, Grenoble (FR); Florent Charras, Grenoble (FR)

Correspondence Address: DICKINSON WRIGHT PLLC, 1901 L. STREET NW, SUITE 800, WASHINGTON, DC, 20036, US

(21) Appl. No.: 10/533,425

(22) PCT Filed: Oct. 23, 2003
(86) PCT No.: PCT/EP03/11744

§ 371 Date: Jan. 11, 2006

(30) Foreign Application Priority Data
Oct. 30, 2002 (DE) 102 50 421.0

(51) Int. Cl. F16L 37/00

(52) U.S. Cl. 285/305

(57) ABSTRACT

Disclosed is a joining element that is part of a fast connecting unit for hydraulic or pneumatic connecting conduits and comprises a tubular basic member (1), onto which two diametrically opposed, laterally spaced-apart two-legged snapping elements (5) are formed. Said snapping elements (5) are connected to the outer wall of the basic member (1) at the swaying point thereof while the free ends of the forward-facing legs thereof are provided with inward-directed hooks (11) which can grip from behind a catching element (12) (undercut) located on the outer wall of a counterpart (4) of the fast connecting unit when the connection is established. The rearward-facing legs of the snapping elements (5) are embodied as spring-type legs (13), the free ends of which are bent back in an inward direction such that a gap (a) remains between said ends and a respective opposite contact area. Said gap (a) limits the swaying movement of the spring-type legs (13) towards the basic member (1) to an extent that corresponds to the movement of expansion of the front legs of the snapping elements (5), which is required to disengage said hooks (11) from the catching element (12) of the counterpart (4), said front legs supporting the hooks (11). In addition, the restoring force of the snapping elements (5) is improved and the connection is secured against being accidentally released if the end of the spring-type legs (13) is bent so as to form a loop (14).

### CROSS-REFERENCE TO RELATED APPLICATIONS

This application is a National Stage of International Application No. PCT/EP03/11744, filed on Oct. 23, 2003, which claims priority to German Patent Application No. 102 50 421.0, filed on Oct. 30, 2002. The disclosures of the above applications are incorporated herein by reference.

### BACKGROUND OF THE INVENTION

The invention relates to a connection element as part of a rapid connection unit for hydraulic or pneumatic connection lines with a tubular base body on which two two-armed snap elements are formed that are diametrically opposite one another, laterally spaced and connected at their rocking point by an elastic connection piece to the outer wall of the base body and comprise inwardly directed hooks on the free ends of their forwardly facing arms that can reach behind a catch element (i.e., undercut) on the outer wall of a counterpiece of the rapid connection unit during establishment of the connection.

DE 41 18 463 A1 teaches such a connection element. The snap elements, extending substantially parallel to the outer wall of the tubular base body are connected at their rocking point by a curved, elastically deformable web to this outer wall. Said inwardly directed hook is formed on the free end of the front arm of each snap element and the particular second arm extends in a straight line to the rear at a radial spacing from the base body. In order to establish a connection, the connection element is inserted by the front end of its base body into the tubular connection part of a counterpiece where it makes a sealing contact in a known manner. The hooks snap on the front ends of the snap elements behind an undercut formed in the outer wall of the counterpiece, which secures the connection against loosening in an unintended manner. In order to loosen the connection, a radial pressure is exerted on the free ends of the backwardly extending second arms of the snap elements, as result of which the connection pieces between the snap elements and the base body act as an articulation and the hooks are loosened from their engagement so that the connection element can be withdrawn from the counterpiece.

The connection element described above has the disadvantage that permanent deformations and even breaks can occur on the connection pieces and the backwardly extending arms of the snap elements when the latter are compressed in the direction of the base body in order to loosen the connection. The return function for the snap elements into their base position is exerted only by the connection pieces and is not reliable. It also turned out that if pressure, e.g., caused by the operation, is exerted on the connection element or also if it is pulled with an appropriate force, the hooks can loosen in an unintended manner from their engagement on the counterpiece.

### SUMMARY OF THE INVENTION

The invention solves the problem described above by creating a connection element of the initially cited type in which a reliable return of the snap elements into their base position is ensured after a loosening process on the connection and a permanent deformation or even a breaking of these snap elements as a consequence of their proper manipulation is reliably avoided. Moreover, greater safety against an unintended loosening of the connection should be achieved.

The invention achieves this in that the backwardly facing arms of the snap elements are designed as spring arms whose free ends are bent back and inward in such a manner that a gap is present between these ends and an opposite contact surface by which gap the rocking movement of the spring arms in the direction of the base body is limited to the degree corresponding to the spreading movement of the front arms of the snap elements carrying the hooks, which spreading movement is necessary for loosening the engagement of the hooks of the catch element of the counterpiece. The fact that the possible movement of the snap elements is limited to the functionally necessary degree in this manner counteracts a permanent deformation of the snap elements. The bent ends of the spring arms impart an effective return force to the snap elements.

According to an embodiment of the invention, the spring arms are first bent back on their end sections slightly concavely outward and then once in the direction of the base body. The gap limiting the rocking movement is present between the free end of the spring arms and the base body.

According to another, preferred embodiment of the invention, the spring arms are bent back inwards twice on their end section so that an open eyelet is formed with said gap between the free end of the open eyelet and the inner surface of the particular spring arm and with a rounding that maintains another gap to the outer wall of the base body. During a rocking movement of the spring arms in the direction of the base body, at first the gap between the outer wall of the base body and the rounding is closed and in a second stage the gap between the free end of the eyelet and the inner surface of the spring arm is closed. The return force for the snap elements is increased even more by the formation of the resiliently deformable eyelet on the end of the spring arms so that the return of the snap elements into their initial position after each actuation is ensured.

According to another embodiment of the invention, level contact surfaces for the ends of the spring arms are formed on the base body and run diametrically opposed to each other in the direction of the central axis.

According to the preferred embodiment, level contact surfaces running diametrically opposed to each other in the direction of the central axis and for the rounding of the particular eyelet facing the base body and for the eyelet section also directed towards the base body as well as stop surfaces standing vertically to these contact surfaces and for the end section of the particular eyelet directed towards the inner surface of the spring arms are formed on the base body. The striking of the end sections of the eyelets directed towards the inner surface of the spring arms against the stop surfaces standing vertically to the central axis prevents loosening of the hooks of the snap elements, e.g., under pressure, from their engagement on the counterpiece in an unintended manner.

### BRIEF DESCRIPTION OF THE DRAWINGS

The invention is described in detail by way of example in the following using the attached drawings.

FIG. 1 shows a perspective view of a first preferred embodiment of a connection element in accordance with the invention.

FIG. 2 shows a lateral view of the connection element according to FIG. 1 and of its counterpiece in the still loosened state.

FIG. 3 shows the lateral view of FIG. 2 with an established connection between the connection element and the counterpiece.

FIG. 4 shows the lateral view according to FIG. 3 when pressure, e.g., caused by operation, is exerted on the established connection.

FIG. 5 shows the lateral view according to FIG. 3 in a loosened position of the connection element.

FIG. 6 shows the lateral view of a second embodiment of a connection element in accordance with the invention.

### DETAILED DESCRIPTION OF THE PREFERRED EMBODIMENT

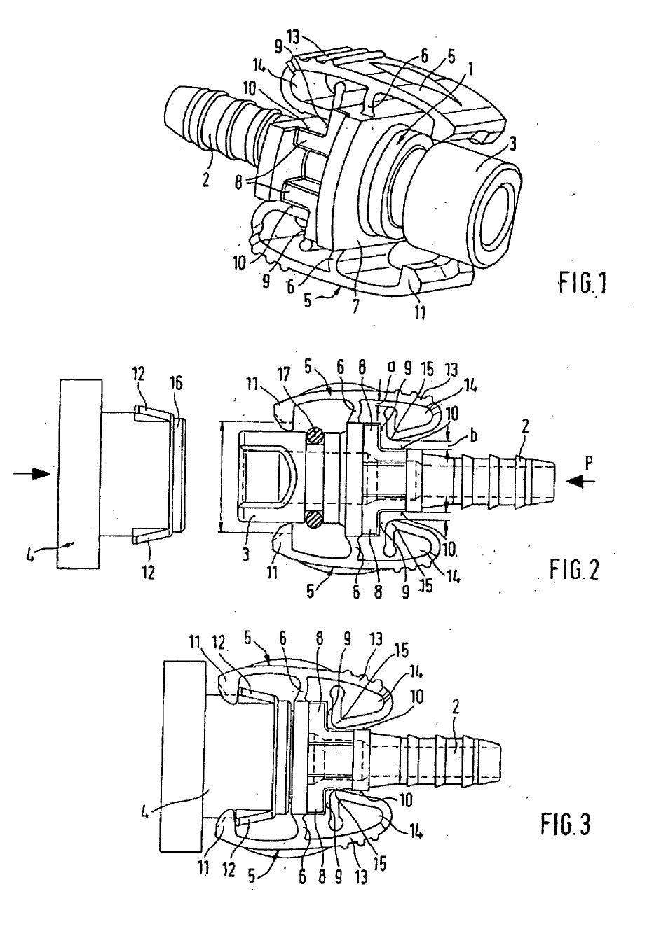

FIG. 1 shows a connection element with tubular base body 1 that merges on its one rear end into connection piece 2 for a pressure-agent line, e.g., a hose, and comprises cylindrical section 3 on its front end upon which the connection element can be pushed in order to establish a connection into correspondingly formed counterpiece 4 (see FIG. 2 and FIGS. 4 to 6) where it makes a sealing contact in a known manner. Diametrically opposed snap elements 5 are arranged on the side of base body 1. They are designed in the manner of a two-armed lever and connected at their rocking point by radially projecting connection piece 6 to base body 1. Connection piece 6 preferably projects from a stop plate 7 protruding from base body 1, upon which counterpiece 4 can come to rest during assembly (see FIG. 3). Two diametrically opposed right-angle formed parts 8 protrude from stop plate 7 in the direction of connection piece 2 with one angle arm of the formed parts 8 running vertically to the axial direction and offering level stop surface 9 while the other angle arm runs in the axial direction and offers level contact surface 10 (see below). Stop plate 7 and formed parts 8 are preferably designed in one piece with base body 1. Inwardly directed hook 11 is formed on the free end of the one lever arm of both snap elements 5 facing counterpiece 4. These hooks 11 slide during the insertion of the connection element into counterpiece 4 along its circumferential surface and finally reach behind an undercut or catch element 12 on the circumference of counterpiece 4 (see FIG. 3). The backwardly directed lever arm of both snap elements 5 is designed as spring arm 13. For this, the end of the spring arm 13 is inwardly bent twice and forms a type of open, elastically deformable eyelet 14 between the end and the inner surface of spring arm 13, forming a gap a that is present in normal position. Another gap b is present in the start position between inwardly facing rounding 15 of eyelet 14 and between horizontal contact surface 10 of formed part 8.

When the connection element according to FIG. 2 is moved in the direction of arrow P into counterpiece 4, the arrangement finally assumes the position according to FIG. 3. Hooks 11 of snap elements 5 reach behind catch element 12 on the outer circumference of counterpiece 4 and stop plate 7 rests with its front surface on the front surface of counterpiece 4 and/or on sealing means 16 provided there, and sealing ring 17 arranged in a groove of cylindrical section 3 rests in a sealing manner in the inner wall of counterpiece 4 and the connection is established. During this procedure the arms of snap element 5 facing counterpiece 4 were slightly spread apart and during the reaching of hooks 11 behind the catch element or elements 12 they do not return completely into their initial position and hooks 11 are therefore under a slight bias so that an unintentional removal of the connection element is counteracted. Moreover, spring arms 13 have moved in the opposite direction during the rocking movement of snap elements 5 around connection piece 6 functioning as a hinge so that inner rounding 15 of eyelet 14 now rests on contact surface 10 of formed part 8 with a slight tension so that a return force becomes active and the tension with which hooks 11 are pressed against the circumferential surface of counterpiece 4 is increased and the connection becomes more secure.

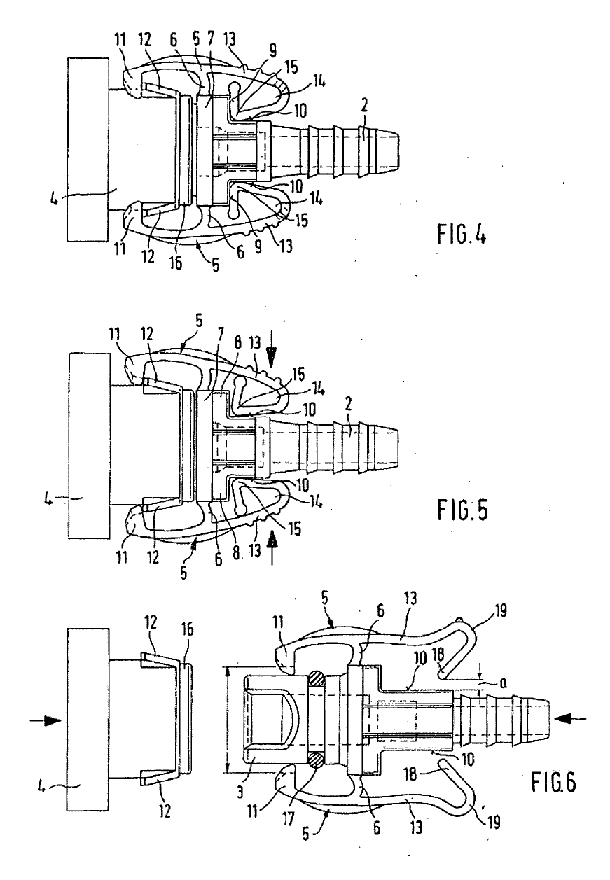

A small gap is present between the end section of eyelets 14 directed towards the inner surface of spring arms 13 and between stop surfaces 9 of formed parts 8 running vertically to the central axis (see FIG. 3). If the arrangement comes under the action of pressure in this state, this gap is closed in that the end section of eyelets 14 comes to rest closely on stop surface 9, which prevents loosening of hooks 11 out of their engagement under pressure and unlocking (see FIG. 4).

If the connection is to be loosened, snap elements 5 are pressed together on their spring arms 13 in the direction of the arrows in FIG. 5. Eyelets 14 come to rest with their section facing base body 1 closely on contact surface 10 and shift at the same time in the direction of stop surface 9 until the section facing back towards spring arm 13 rests closely on stop surface 9. During further compression of spring arms 13 they are slightly deformed until the free end of eyelets 14 facing the inner side of spring arms 13 strike this inner side, thus preventing a further pressing together of spring arms 13 and a possibly resulting permanent deformation. The interval of the free end of eyelets 14 to the inner side of spring arms 13 is selected in such a manner that the front arms of snap element 5 facing counterpiece 4 are spread apart to such an extent that hooks 11 loosen out of their engagement on catch elements 12. Then, the connection element can be removed from counterpiece 4 and the connection can therefore be loosened. Snap elements 5 return thereafter to their initial position according to FIG. 2 by the return force of spring arms 13 or of eyelets 14 formed on them.

FIG. 6 shows a second embodiment of the connection element of the invention. The same parts are characterized by the same reference numerals. In distinction to the above-described embodiment, in this instance backwardly directed spring arms 13 of snap elements 5 are at first bent back slightly outward and their ends then bent only in the direction of base body 1.

Continuing with the embodiment in FIG. 6, gap a is present between free end 18 of this hook-shaped end section 19 and contact surface 10 of formed part 8 and limits the movement of spring arms 13 and therewith of snap elements 5 during the loosening procedure in order to prevent a permanent deformation of snap elements 5.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

1. A connection element as part of a rapid connection unit for connection lines, comprising a tubular base body on which at least two two-armed snap elements are formed that are diametrically opposite one another, laterally spaced and connected at a rocking point by an elastic connection piece to an outer wall of the base body and comprise inwardly directed hooks capable of engaging a catch element on an outer wall of a counterpiece of the rapid connection unit wherein the snap elements (5) comprise spring arms (13) whose free ends are bent back and inward in such a manner that a gap (a) is present between these free ends and an opposite contact surface in an engaged position, said opposite contact surface limiting rocking movement of said snap elements such that inwardly directing hooks disengage said catch elements

2. The connection element according to claim 1, wherein the spring arms (13) comprise at least two bent portions, a first of said at least two bent portions being bent slightly concavely outward and a second of said at least two bent portions being bent in a direction of the base body (1) and the gap (a).

3. (cancelled)

4. The connection element according to claim 1, wherein the contact surfaces (10) are formed on the base body (1) and run diametrically opposed to each other in a direction of a central axis.

5. (cancelled)

6. A connection element for connecting a connection line to a counterpiece, comprising:
a base body;
a stop piece operably coupled to a first end of said base body;
a stop plate operably coupled to a second end of said base body;
a first connection piece operably coupled to said first end of said base body, said first connection piece being capable of receiving said connection line;
a second connection piece operably coupled to said second end of said base body, said second connection piece being capable of being releasably coupled to said counterpiece; and
at least two snap elements, each of said snap elements being capable of releasably securing said counterpiece to said connection element and comprising:
a first snap element end comprising a spring arm;
a second snap element end comprising a hook; and
a connection piece arranged between said first and second snap element ends,
said connection piece being operably coupled to base body; wherein
said snap element is biased such that said hook engages with a catch element of said counterpiece in an engaged position, and
said spring arm interacts with said stop piece to limit travel of said snap element in a release position.

7. The connection element of claim 6, wherein said counterpiece contacts said stop plate in said engaged position such that movement of said counterpiece is restricted in a first direction by said hooks and in a second direction by said stop plate.

8. The connection element of claim 6, wherein said second end of said base body comprises a sealing ring, said sealing ring being capable of sealing said counterpiece to said base body in said engaged position.

9. The connection element of claim 6, wherein said spring arm comprises a rounding, said rounding being capable of interacting with said stop piece to limit travel of said snap element in said release position.

10. The connection element of claim 6, wherein said stop piece comprises a first contact surface, said first contact surface contacting said spring arm in said engaged position.

11. The connection element of claim 10, wherein said stop piece further comprises a second contact surface, said second contact surface contacting said spring arm in said release position.

12. The connection element of claim 11, wherein said first and second contact surfaces cooperate with said spring arm to limit travel of said snap element in said release position.

13. The connection element of claim 12, wherein said second end of said base body comprises a sealing ring, said sealing ring being capable of sealing said counterpiece to said base body in said engaged position.

14. The connection element of claim 13, wherein said spring arm comprises a rounding, said rounding being capable of interacting with said stop piece to limit travel of said snap element in said release position.

15. The connection element of claim 6, wherein said connection piece permits a rocking motion of said snap element.

16. The connection element of claim 15, wherein said counterpiece contacts said stop plate in said engaged position such that movement of said counterpiece is restricted in a first direction by said hooks and in a second direction by said stop plate.

17. The connection element of claim 16, wherein said stop piece comprises a first contact surface, said first contact surface contacting said spring arm in said engaged position.

18. The connection element of claim 17, wherein said stop piece further comprises a second contact surface, said second contact surface contacting said spring arm in said release position.

19. The connection element of claim 18, wherein said first and second contact surfaces cooperate with said spring arm to limit travel of said snap element rocking motion in said release position.

20. The connection element of claim 19, wherein said second end of said base body comprises a sealing ring, said sealing ring being capable of sealing said counterpiece to said base body in said engaged position.

21. The connection element of claim 20, wherein said spring arm comprises a rounding, said rounding being capable of interacting with said stop piece to limit travel of said snap element in said release position.
